(19) United States
(12) Patent Application Publication
(10) Pub. No.: US 2011/0134085 A1
(43) Pub. Date: Jun. 9, 2011

(54) INPUT DEVICE

(75) Inventor: Naoaki Matsui, Fukui (JP)

(73) Assignee: Panasonic Corporation, Osaka (JP)

(21) Appl. No.: 12/952,627

(22) Filed: Nov. 23, 2010

(30) Foreign Application Priority Data
Dec. 7, 2009 (JP) 2009-277283

(51) Int. Cl. G09G 5/00

(52) U.S. Cl. 345/184

(57) ABSTRACT

In an input device, a switch contact is partially located under a display element, and one of a case and an operation body includes grooves, and the other includes projections to be engaged with the grooves. This saves the space of the top surface of a wiring board, thereby reducing the entire size of the input device. This also allows the operation body to move vertically by the grooves and the projections. As a result, the operation body is prevented from wobbling or tilting, thereby ensuring the electrical connection and disconnection of the switch contact.

### BACKGROUND OF THE INVENTION

1. Field of the Invention

The present invention relates to input devices mainly for operating air conditioners, audio systems, and other electronic devices used in automobiles.

2. Background Art

In recent years, an increasing number of automobiles and other vehicles are equipped on their front panel with an input device having various operation bodies for operating an air conditioner, an audio system, and other electronic devices.

Such a conventional input device will be described as follows with reference to FIGS. 3 and 4.

FIG. 3 is a sectional view of the conventional input device, and FIG. 4 is an exploded perspective view of the input device. In FIGS. 3 and 4, the input device includes case 1, which is made of an insulating resin and is shaped like a bottomless box. Case 1 has window 1A and hole 1B on its top surface. The input device further includes display panel 2 made of a dark light-transmissive insulating resin. Display panel 2 includes hole 2A and is pasted on the top surface of case 1.

The input device further includes operation body 3, which is made of an insulating resin and is shaped like a square prism. Operation body 3 is stored in case 1. Operation body 3 includes operating part 3A at its top end, and pressing part 3B at its bottom end. Operating part 3A can move vertically and project from hole 2A of display panel 2 through hole 1B of case 1.

The input device further includes wiring board 4, which is provided on its top and bottom surfaces with wiring patterns (not shown). Display element 5 such as a fluorescent display tube is mounted on the top surface of wiring board 4. Display element 5 includes terminals 5A with which display element 5 is mounted on wiring board 4, and display part 5B, which faces window 1A of case 1.

The input device further includes switch contact 6 such as a push switch, which is arranged side by side with display element 5 on the top surface of wiring board 4. Switch contact 6 includes housing 6A, and push button 6B projecting therefrom. The top surface of push button 6B can come into contact with pressing part 3B of operation body 3.

The input device further includes cover 7, which is made of an insulating resin and covers the open bottom of case 1 so as to store operation body 3, wiring board 4, display element 5, and other components in case 1.

The input device thus structured is attached to the front panel at the front of an automobile in such a manner that display panel 2 is located on the front side. Display element 5 and switch contact 6 are electrically connected to an electronic circuit (not shown) of the automobile via connectors or lead wires (not shown). The electronic circuit controls an air conditioner, an audio system, and other electronic devices installed in the automobile.

When the electronic circuit controls display part 5B of display element 5 to display, for example, the time “10:02”, the user can see the time through window 1A of case 1 and display panel 2 which covers case 1.

Assume that the user presses operating part 3A to synchronize it with the time signal. Then, operation body 3 moves downward, allowing pressing part 3B at the bottom of operation body 3 to press push button 6B, thereby allowing switch contact 6 to perform electrical connection and disconnection. The electronic circuit detects this, and resets the time on display part 5B to, for example, “10:00”.

Thus, display element 5 of the input device attached to the front panel displays the current time, the temperature of the air conditioner, the volume of the audio system, and other information. When the user presses operation body 3, switch contact 6 performs electrical connection and disconnection, thereby resetting the time, changing the temperature or the volume, or performing other operations.

In the conventional input device, however, display element 5 and switch contact 6 are arranged side by side on the top surface of wiring board 4. This makes it difficult to save the space of the top surface of wiring board 4, and hence it is difficult to reduce the entire size of the input device.

### SUMMARY OF THE INVENTION

The input device of the present invention includes a case having a hole on the top surface thereof, an operation body, a display element stored in the case, and a switch contact. The operation body has an operating part at the top end thereof and a pressing part at the bottom end thereof. The operating part moves vertically and projects from the hole. One of the case and the operation body includes a groove, and the other includes a projection to be engaged with the groove. The switch contact is partially located under the display element, and performs electrical connection and disconnection when the switch contact is pressed by the pressing part of the operation body.

### BRIEF DESCRIPTION OF THE DRAWINGS

FIG. 1 is a sectional view of an input device according to an embodiment of the present invention.

FIG. 2 is an exploded perspective view of the input device shown in FIG. 1.

FIG. 3 is a sectional view of a conventional input device.

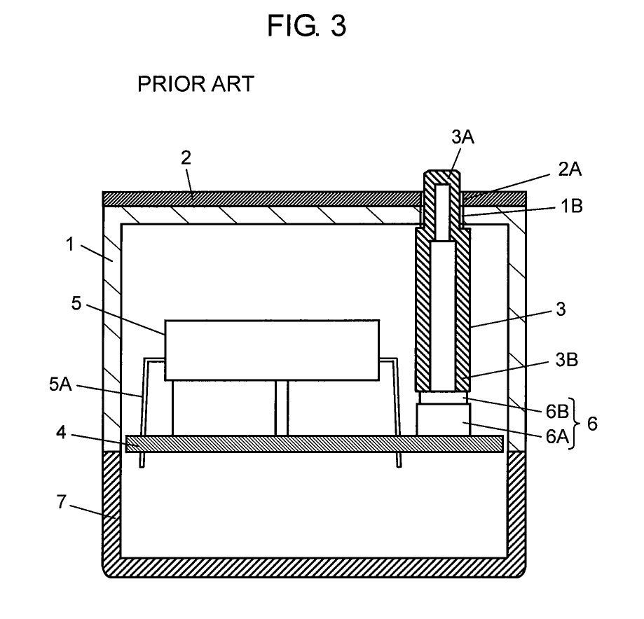

FIG. 4 is an exploded perspective view of the input device shown in FIG. 3.

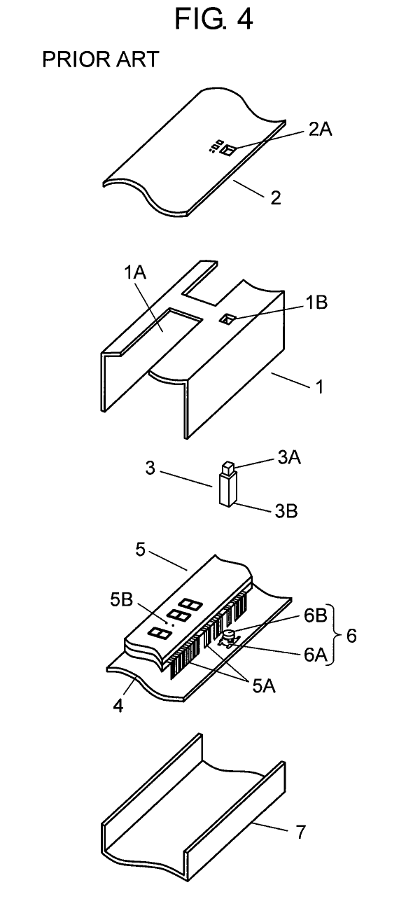

### DETAILED DESCRIPTION OF THE INVENTION

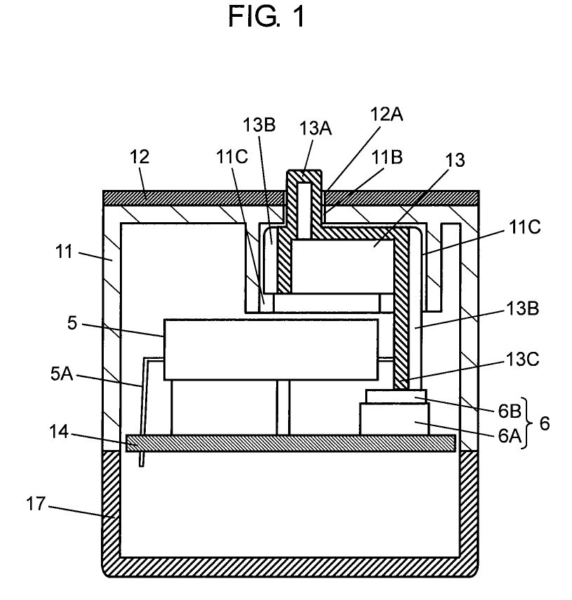

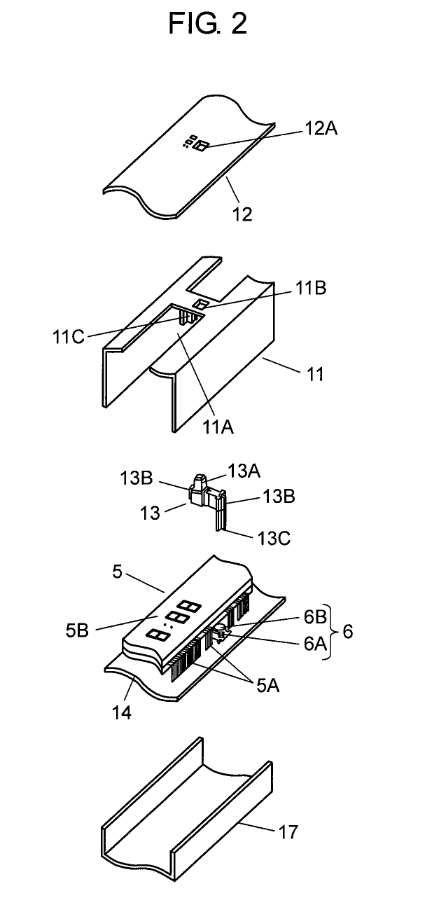

An embodiment of the present invention will be described as follows with reference to FIGS. 1 and 2.

### EMBODIMENT

FIG. 1 is a sectional view of an input device according to the embodiment of the present invention. FIG. 2 is an exploded perspective view of the input device shown in FIG. 1. The input device includes case 11, which is made of an insulating resin such as polycarbonate or ABS and is shaped like a bottomless box. Case 11 has window 11A and hole 11B on its top surface, and a pair of left and right grooves 11C extending downward from the rear side of the top surface of case 11. The input device further includes display panel 12 made of a dark light-transmissive insulating resin such as acryl. Display panel 12 includes hole 12A, and is pasted on the top surface of case 11.

The input device further includes operation body 13, which is made of an insulating resin such as ABS, and has an L-shaped profile. Operation body 13 includes operating part 13A at its top left end, and pressing part 13C at its bottom right end. Operating part 13A can move vertically and project from hole 12A of display panel 12 through hole 11B of case 11. Operation body 13 further includes wall-like projections 13B formed at its left and right ends, which are inserted into and engaged with grooves 11C of case 11.

The input device further includes wiring board 14 made of paper phenol or glass-filled epoxy. Wiring board 14 is provided on its top and bottom surfaces with wiring patterns (not shown) made of, for example, copper. Display element 5 such as a fluorescent display tube is mounted on the top surface of wiring board 14. Display element 5 includes terminals 5A with which display element 5 is mounted on wiring board 14, and display part 5B, which faces window 11A of case 11.

The input device further includes switch contact 6 such as a push switch. Switch contact 6 is arranged beside display element 5 on the top surface of wiring board 14 in such a manner that switch contact 6 is partially located under display element 5 and between terminals 5A. The top surface of push button 6B projecting from housing 6A can come into contact with pressing part 13C of operation body 13.

The input device further includes cover 17, which is made of an insulating resin such as ABS and covers the open bottom of case 11 so as to store operation body 13, wiring board 14, display element 5, and other components in case 11.

Thus, switch contact 6 is partially located under display element 5 and between terminals 5A. Pressing part 13C, which comes into contact with push button 6B of switch contact 6, is provided at the bottom right end of operation body 13. Operating part 13A is provided at the top left end of operation body 13, which is a little apart from pressing part 13C. Forming operation body 13 in an L shape can save the space of the top surface of wiring board 14, allowing case 11, display panel 12, and wiring board 14 to have a smaller size in the transverse direction, thereby achieving a compact input device.

The input device thus structured is attached, for example, to the front panel at the front of an automobile in such a manner that display panel 12 is located on the front side. Display element 5 and switch contact 6 are electrically connected to an electronic circuit (not shown) of the automobile via connectors or lead wires (not shown). The electronic circuit controls an air conditioner, and an audio system, and other electronic devices installed in the automobile.

When the electronic circuit controls display part 5B of display element 5 to display, for example, the time “10:02”, the user can see the time through window 11A of case 11 and display panel 12 which covers case 11.

Assume that the user presses operating part 13A to synchronize it with the time signal. Then, operation body 13 moves downward, allowing pressing part 13C at the bottom of operation body 13 to press push button 6B, thereby allowing switch contact 6 to perform electrical connection and disconnection. The electronic circuit detects this, and resets the time on display part 5B to, for example, “10:00”.

Thus, display element 5 of the input device attached to the front panel displays the current time, the temperature of the air conditioner, the volume of the audio system, and other information. When the user presses operation body 13, switch contact 6 performs electrical connection and disconnection, thereby resetting the time, changing the temperature or the volume, or performing other operations.

Since operation body 13 is formed in an L shape, when the user presses operating part 13A at the top left end of operation body 13, push button 6B of switch contact 6 is pressed by pressing part 13C. Pressing part 13C is a little apart from operating part 13A, that is, at the bottom right end of operation body 13. Projections 13B formed at the left and right ends of operation body 13 are inserted into and engaged with grooves 11C of case 11, thereby preventing operation body 13 from wobbling or tilting.

More specifically, a pair of left and right grooves 11C extend downward in case 11, and wall-like projections 13B are formed at the left and right ends of operation body 13 in such a manner as to be inserted into and engaged with grooves 11C. Operation body 13 is guided to move vertically by grooves 11C and projections 13B from both sides. This prevents operation body 13 from wobbling or tilting, although operating part 13A and pressing part 13C are apart from each other, thereby ensuring the electrical connection and disconnection of switch contact 6.

As described above, operation body 13 is formed in an L shape, and switch contact 6 is partially located under display element 5 and between terminals 5A. This saves the space of the top surface of wiring board 14, allowing case 11, display panel 12, and wiring board 14 to have a smaller size in the transverse direction, thereby achieving a compact input device.

In the above description, a pair of grooves 11C are provided in the case 11, and projections 13B to be engaged with grooves 11C are provided on both sides of operation body 13. Alternatively, the projections can be provided in case 11, and the grooves to be engaged with the projections can be provided on both sides of operation body 13. This prevents operation body 13 from wobbling or tilting in the same manner, thereby implementing the present invention.

According to the present embodiment, switch contact 6 is partially located under display element 5, and one of case 11 and operation body 13 includes grooves 11C, and the other includes projections 13B to be engaged with grooves 11C. This saves the space of the top surface of wiring board 14, thereby reducing the entire size of the input device. Furthermore, operation body 13 is guided to move vertically by grooves 11C and projections 13B so as to be prevented from wobbling or tilting, thereby ensuring the electrical connection and disconnection of the switch contact 6 in the input device.

In the above description, the push switch is mounted as switch contact 6 on the top surface of wiring board 14. Alternatively, it is possible to mount a plurality of fixed contacts made, for example, of carbon on the top surface of wiring board 14 and to mount dome-shaped movable contacts made of conductive sheet metal on the fixed contacts. Various other switch contacts can alternatively be used to implement the present invention, such as a rubber push button having a movable contact at its bottom surface above a fixed contact.

As described hereinbefore, the present invention provides a compact and reliable input device mainly for operating air conditioners, audio systems, and other electronic devices used in automobiles.

What is claimed is:

1. An input device comprising:
a case having a hole on a top surface thereof;
an operation body having an operating part at a top end thereof and a pressing part at a bottom end thereof, the operating part moving vertically and projecting from the hole;
a display element stored in the case; and
a switch contact partially located under the display element, the switch contact performing electrical connection and disconnection when the switch contact is pressed by the pressing part of the operation body, wherein
one of the case and the operation body includes a groove, and an other includes a projection to be engaged with the groove.

2. The input device of claim 1, wherein
the operation body is formed in an L shape.

3. The input device of claim 1, wherein
the operating part is located above the display element.
